(19) United States
(12) Patent Application Publication
(10) Pub. No.: US 2018/0311874 A1
(43) Pub. Date: Nov. 1, 2018

(54) METHOD OF MANUFACTURING SEAL ASSEMBLY WITH LOCATOR

(71) Applicant: Henniges Automotive Sealing Systems North America, Inc., Wilmington, DE (US)

(72) Inventor: Matt Thomson, Reidsville, NC (US)

(73) Assignee: Henniges Automotive Sealing Systems North America, Inc., Wilmington, DE (US)

(21) Appl. No.: 15/770,268

(22) PCT Filed: Oct. 26, 2016
(86) PCT No.: PCT/US2016/058820

§ 371 Date: Apr. 23, 2018

Related U.S. Application Data
(60) Provisional application No. 62/246,382, filed on Oct. 26, 2015.

(51) Int. Cl. B29C 45/14

(52) U.S. Cl. CPC B29C 45/14409; B29C 45/14467

(57) ABSTRACT

A method of manufacturing a seal assembly for attachment to a vehicle having a mounting point and a vehicle point spaced from the mounting point at a distance with an apparatus having first and second receptacles, a cavity, and a locator receptacle spaced from the cavity, including: extruding a first strip to form a first body between first ends; extruding a second strip to form a second body between second ends; providing a locator; positioning the locator into the locator receptacle; positioning a first end into the first receptacle with the first body engaging the locator; positioning a second end into the second receptacle; forming a mold at the cavity bonding the strips together at a mold point; and bonding the locator to the first body so a distance between the bonded locator and the mold point is equal to the distance between the mounting point and the vehicle point.

### CROSS-REFERENCE TO RELATED APPLICATION

The subject patent application claims priority to and all the benefits of U.S. Provisional Patent Application Ser. No. 62/246,382 which was filed on Oct. 26, 2015, the disclosure of which is hereby incorporated by reference.

### TECHNICAL FIELD

The present invention relates, generally, to seal assemblies and, more specifically, to a method of manufacturing a seal assembly with a locator.

### BACKGROUND

Conventional seal assemblies are used in a number of different industries to provide a seal between different components which may be movable relative to one another. By way of non-limiting example, seal assemblies such as weatherstrips, weatherseals, glassrun moldings, window seals, and the like are used in the automotive industry to seal between a vehicle door defining a window opening, and a glass panel supported for sliding movement relative to the door to selectively close the window opening. These conventional seal assemblies may be operatively attached to different portions of the vehicle in a number of different ways, such as with fasteners, clips, and the like.

Those having ordinary skill in the art will appreciate that seal assemblies may be manufactured in a number of different ways to suit specific vehicle application requirements. To this end, conventional seal assemblies are formed from one or more extruded members which are molded together, such as with a plastic injection process, which bonds the extruded members together at a predetermined location corresponding to a portion of the vehicle, such as at a corner of the window opening, to form a molded seal assembly. In order to facilitate attachment to the vehicle, various clips and/or locators are often subsequently attached to the molded seal assembly at predetermined locations which correspond to fastening locations of the particular vehicle. To this end, holes or other formations may be defined in one or more of the extruded members prior to molding, and clips, fasteners, locators, and the like may be subsequently installed into the holes/formations after the molded seal assembly has been formed. It will be appreciated that this approach necessitates that the pre-formed holes/formations be aligned properly prior to molding the seal assembly extrusions together, which may be cumbersome and/or labor intensive and may result in ineffective alignment of the molded seal assembly within the window opening of the vehicle. Moreover, tolerance stack-up inherent in the manufacturing of extruded components, as well as changes in the length of the extruded components after exposure to head during the formation the molding, may further exacerbate misalignment of the completed molded seal assembly.

Another approach conventionally used in the related art is to form the holes/formations after the molded seal assembly has been formed, and subsequently install the clips, fasteners, locators, and the like. However, it will be appreciated that this approach may be labor intensive, may necessitate expensive tooling. Here, tolerance stack-up and labor intensive assembly generally lead to high scrap rates, in particular where vehicle application requirements dictate tight tolerances in the finished molded seal assembly.

While methods of manufacturing seal assemblies known in the related art have generally performed well for their intended purpose, there remains a need in the art for a method of manufacturing seal assemblies which can achieve required manufacturing tolerances, and which can be manufactured in a consisted, cost-effective manner while, at the same time, promoting improved sealing performance in a number of different applications.

### SUMMARY OF THE INVENTION

The present invention overcomes the disadvantages in the prior art in a method of manufacturing a seal assembly for attachment to a vehicle having a mounting point and defining a vehicle reference point spaced from the mounting point at a predetermined distance. The method utilizes a molding apparatus having a first receptacle and a second receptacle and defining a mold cavity, and a locator receptacle mounted to the molding apparatus outside of the mold cavity. The method includes the steps of: extruding a first strip of material to form a first body extending between opposing first strip ends; extruding a second strip of material to form a second body extending between opposing second strip ends; providing a locator; positioning the locator into the locator receptacle; positioning one of the first strip ends into the first receptacle with a portion of the first body engaging a portion of the locator; positioning one of the second strip ends into the second receptacle;

directing material into the mold cavity to form a joint mold bonding the first strip together with the second strip with the joint mold defining a mold reference point; and bonding the locator outside of the mold cavity to the first body at a location along the first strip spaced from the mold reference point such that a distance between the bonded locator and the mold reference point is equal to the predetermined distance between the mounting point and the vehicle reference point.

In this way, the method of the present invention affords significant advantages for manufacturing seal assemblies in a cost-effective manner while, at the same time, ensuring proper fitment on vehicles in a number of different applications without necessitating the use of complex, labor-intensive, or otherwise unreliable manufacturing processes.

### BRIEF DESCRIPTION OF THE DRAWINGS

Advantages of the present invention will be readily appreciated as the same becomes better understood by reference to the following detailed description when considered in connection with the accompanying drawings.

FIG. 1 is a partial side view of a vehicle including a seal assembly according to one embodiment of the present invention.

FIG. 2 is a front-side plan view of the window seal assembly of FIG. 1 shown having a locator.

FIG. 3 is an enlarged partial back-side plan view of the window seal assembly taken from indicia 3 in FIG. 2.

FIG. 4 is a sectional view taken along line 4-4 in FIG. 3.

FIG. 5 is a perspective view of a molding system for use in manufacturing the window seal assembly of FIGS. 2-4.

FIG. 6 is an angled perspective view of components of the window seal assembly of FIGS. 2-4 in a pre-assembly configuration, showing the locator adjacent to a first strip of the seal assembly.

FIG. 7 is an angled partial perspective view of the molding system of FIG. 5, shown having a molding apparatus with a first receptacle, a second receptacle, and a third receptacle, and defining a mold cavity, and with a locator receptacle into which the locator depicted in FIG. 6 is positioned.

FIG. 8 is another angled partial perspective view of the molding system of FIG. 7, shown with a portion of a first strip positioned into the first receptacle and engaging the locator, with a portion of a second strip positioned partially in the second receptacle, and with a portion of a third strip positioned partially in the third receptacle.

FIG. 9 is another angled partial perspective view of the molding system of FIG. 7, shown with the seal assembly formed with a joint mold bonding the strips together and with the locator bonded to the first strip.

FIG. 10 is a partial perspective view of the seal assembly of FIG. 9 shown formed with the joint molding and the bonded locator.

FIG. 11 is a perspective view of a locator receptacle for use with a molding system according to another embodiment, the locator receptacle shown in a closed orientation.

FIG. 12 is a perspective view of another embodiment of a molding system shown having the locator receptacle of FIG. 11 mounted to a molding apparatus in which first, second, and third strips are positioned.

FIG. 13 is a perspective view of the molding system of FIG. 12 shown with the locator receptacle shown in an opened orientation, and shown with the first, second, and third strips bonded together with a joint molding and moved away from a portion of the molding apparatus into a released orientation.

FIG. 14 is an angled perspective view of the locator receptacle of the molding system of FIGS. 12 and 13 shown in the open orientation with the locator bonded to the first strip and released from the locator receptacle.

### DETAILED DESCRIPTION

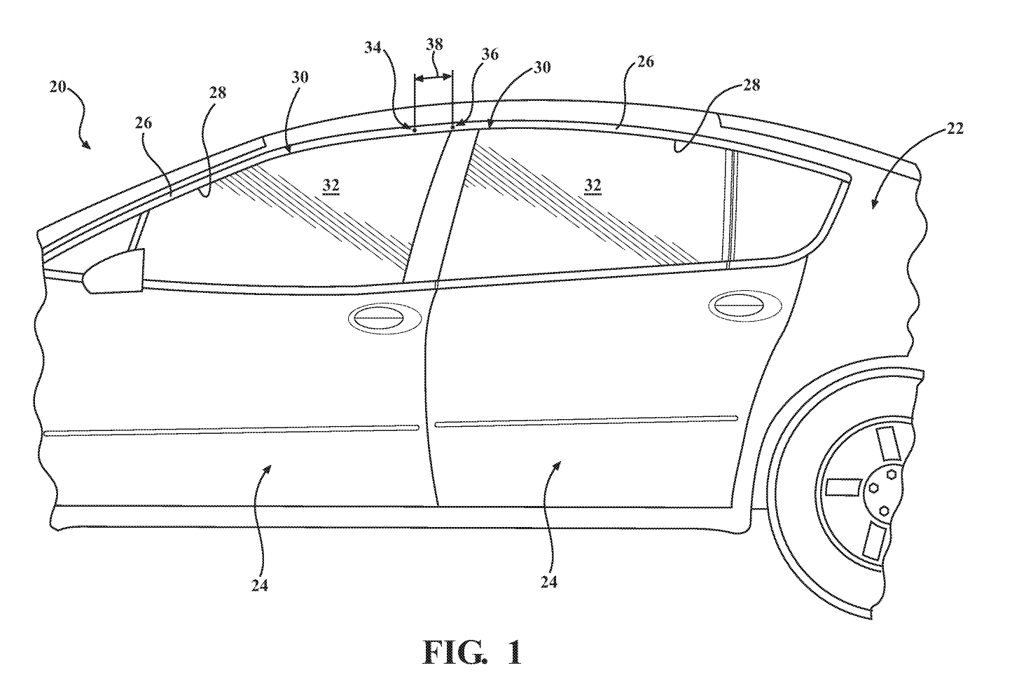

Referring now to the drawings, wherein like numerals indicate corresponding parts throughout the several views, a portion of an automotive passenger vehicle is shown at 20 in FIG. 1. The vehicle 20 has a body, generally indicated at 22, and a plurality of doors 24 coupled to the body 22. Each of the doors 24 has a window frame 26 defining a window 28, and seal assembly 30 adjacent to the window frame 26. In the representative embodiment illustrated herein and depicted throughout the drawings, the seal assembly 30 is realized as a window seal assembly 30 which is coupled to and extends along at least a portion of the window frame 26, as described in greater detail below. However, those having ordinary skill in the art will appreciate that the seal assembly 30 could be realized in a number of different ways, for different vehicle 20 applications or for different types of vehicles 20, without departing from the scope of the present invention. Moreover, while the present invention is adapted for use with automotive passenger vehicles, it will be appreciated that the seal assembly 30 could be used in connection with any type of vehicle, such as heavy-duty trucks, trains, airplanes, ships, construction vehicles or equipment, military vehicles, or any other type of vehicle that utilizes seal assemblies 30.

With continued reference to FIG. 1, each of the doors 24 also includes a window closure member 32 (such as a glass window pane) movable between open and closed positions with respect to the window frame 26 and at least partially received within the seal assembly 30 when the window closure member 32 is in the closed position (not shown in detail, but generally known in the art). Furthermore, the vehicle 20 also has a mounting point, generally indicated at 34, and the vehicle 20 defines a vehicle reference point, generally indicated at 36, which is spaced form the mounting point 34 at a predetermined distance 38. As is explained in greater detail below, the predetermined distance 38 between the vehicle 20 mounting point 34 and the vehicle reference point 36 correspond, respectively, to a location 40 and a mold reference point 42 of the seal assembly 30 which are spaced from each other at a distance 44 which is equal to the predetermined distance 38 between the mounting point 34 and the vehicle reference point 36 of the vehicle 20. The mounting point 34, the vehicle reference point 36, the location 40, and the mold reference point 42 will each be described in greater detail below.

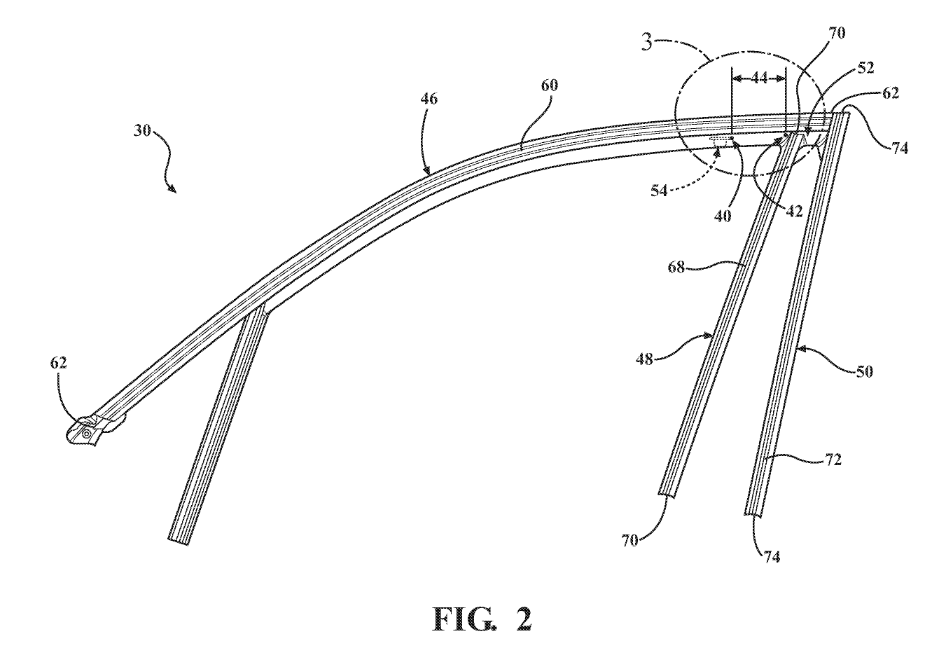

Referring now to FIG. 2, the seal assembly 30 includes a first strip 46 and a second strip 48 operatively attached to the first strip 46, as described in greater detail below. In the representative embodiment illustrated herein, the first strip 46 has a curved profile and is operatively attached to both the second strip 48 as well as to a third strip 50 via a joint mold 52 which bonds the strips 46, 48, 50 together. Specifically, the joint mold 52 of the seal assembly 30 couples the first strip 46 and the second strip 48 (and, in some embodiments, also the third strip 50) together in a predetermined orientation that is complimentary to the shape and orientation of the window frame 26 of the vehicle 20, as described in greater detail below. Here, the joint mold 52 defines the mold reference point 32 noted above and is formed as is described in greater detail below. It will be appreciated that the seal assembly 30 could be of different shapes and configurations to suit particular vehicle 20 applications and, thus, could employ additional strips and/or joint molds without departing from the scope of the present invention. By way of non-limiting example, in the representative embodiment illustrated in FIG. 2, the seal assembly 30 includes a total of four strips, two joint molds, and end mold formations (not shown in detail, but generally known in the related art).

The first strip 46 and, generally, also the second strip 48 and/or the third strip 50, seals against the window closure member 32 in the closed position (not shown in detail, but generally known in the art). However, those having ordinary skill in the art will appreciate that the seal assembly 30 could have any suitable profile, shape, or configuration sufficient to effect receiving the window closure member 32 in the closed position without departing from the scope of the present invention. By way of non-limiting example, the seal assembly 30 could omit the third strip 50 for certain applications, and each of the strips 46, 48, 50 and the joint mold 52 could be implemented with respectively different shapes, profiles, arrangements, and the like.

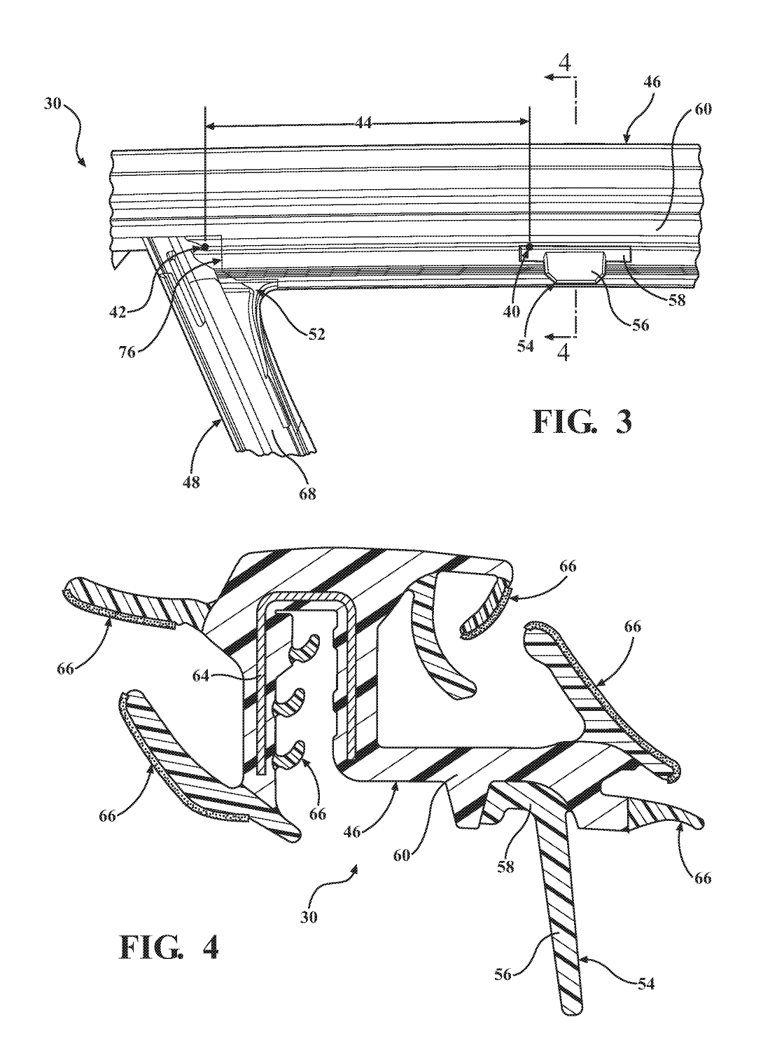

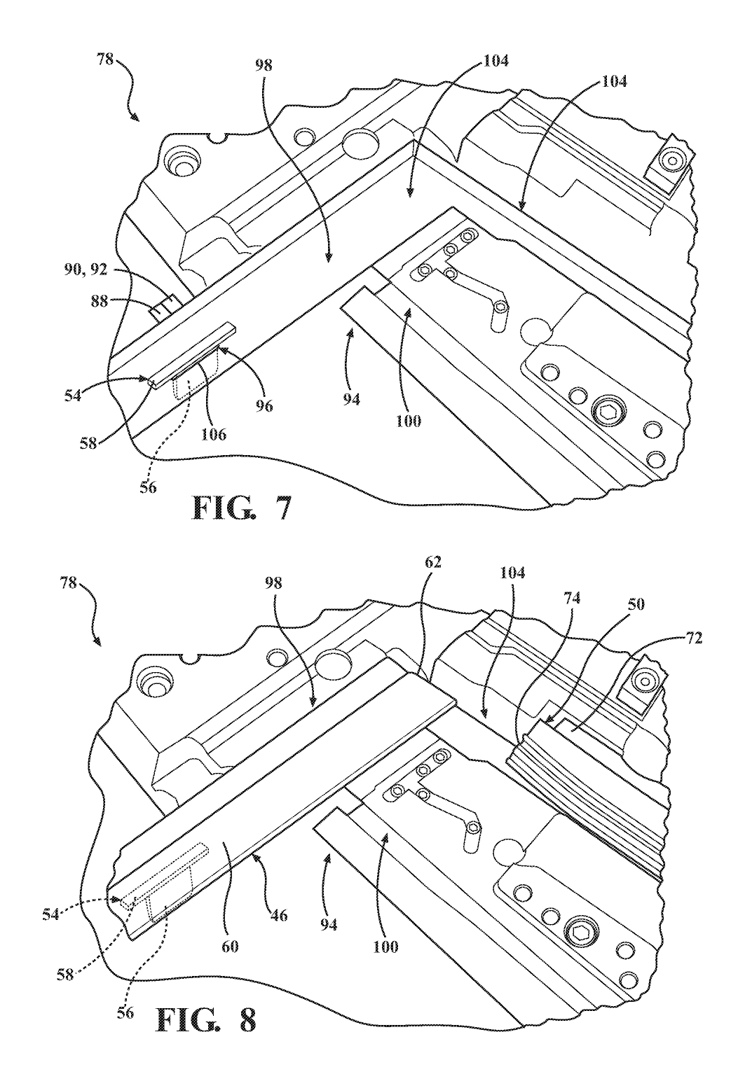

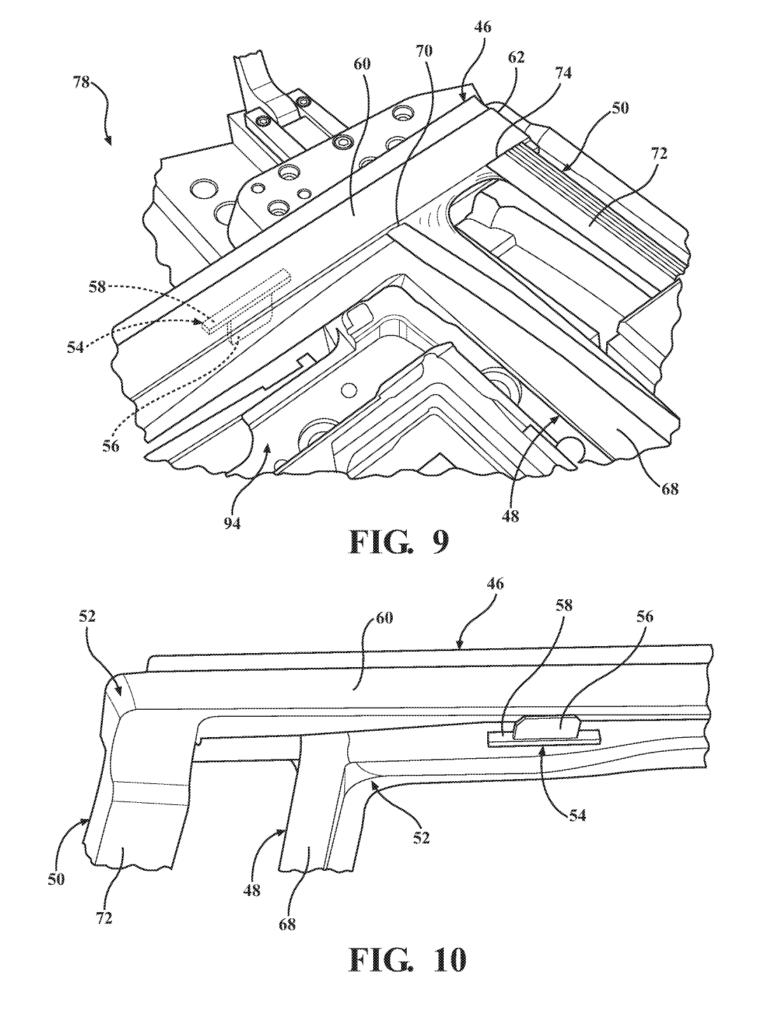

The seal assembly 30 further includes a locator 54 (shown in phantom in FIG. 2; see also FIGS. 3, 4, and 6-10). The locator 54 is operatively attached to the seal assembly 30 and helps align the seal assembly 30 within the window frame 26 of the vehicle 20 during installation, and may also be utilized to help align the various components of the seal assembly 30 itself during manufacturing. To this end, the locator 54 is heat bonded to the first strip 46 at the location 40 noted above, and is spaced from the mold reference point 42 at the distance 44 such that the distance 44 is equal to the predetermined distance 38 between the mounting point 34 and the vehicle reference point 36 of the vehicle 20 (compare FIG. 1 to FIGS. 2 and 3).

In the representative embodiment illustrated herein, and as is best depicted in FIG. 6, the locator 54 is a unitary, one-piece component and has a tab 56 and a foot 58. The foot 58 is operatively attached to the first strip 46 via heat bonding, as described in greater detail below, and the tab 56 is configured to be received in a corresponding attachment feature of the vehicle 20 at the mounting point 34, such as in a recess defined in the window frame 26 of the vehicle 20 (not shown, but generally known in the related art). It will be appreciated that this configuration allows the seal assembly 30 to be positioned within the window frame 26 so as to ensure a proper seal against the window closure member 32, the window frame 26, the door 24, and/or the body 22 of the vehicle 20. Moreover, it will be appreciated that the locator 54 could be of any suitable type or configuration sufficient to align the seal assembly 30 and to attach to the first strip 46, as noted above, without departing from the scope of the present invention.

Referring now to FIG. 4, a portion of the first strip 46 of the seal assembly 30 is shown in cross-section. The first strip 46 has a first body, generally indicated at 60, which is formed such as via extrusion process, and which extends between opposing first strip ends 62 (see FIG. 2). In one embodiment, the first body 60 of the first strip 46 supports a carrier 64 therein. The carrier 64 may be manufactured from metal, such as steel, or from any other suitable material without departing from the scope of the present invention. In the representative embodiment illustrated herein, the first body 60 of the first strip 46 further includes a plurality of lips, generally indicated at 66, for abutting or otherwise engaging specific portions of the body 22 of the vehicle 20, the door 24, the window frame 26, and/or the window closure member 32 (not shown in detail, but generally known in the art).

It will be appreciated that the first body 60 and/or the lips 66 of the first strip 46 could be manufactured from any suitable material or combination of materials, and could be formed in any suitable way, without departing from the scope of the present invention. By way of non-limiting example, the first strip 46 could be manufactured via a plastic extrusion process utilizing one or more predetermined materials, such as from one or more types of EPDM (Ethylene Propylene Diene Monomer) rubber and/or TPV (ThermoPlastic Vulcanized) rubber. Here too, the second strip 48 and/or the third strip 40 are advantageously manufactured via a plastic extrusion process. In the representative embodiment illustrated herein, and as is best depicted in FIG. 2, the second strip 48 has a second body 68 which extends between opposing second strip ends 70, and the third strip 50 has a third body 72 which extends between opposing third strip ends 74.

As noted above, ensuring proper orientation of the various components of the seal assembly 30 during manufacturing ensures proper alignment of the seal assembly 30 within the window frame 26 of the vehicle 20. Specifically, in the representative embodiment illustrated herein, the predetermined distance 38 between the mounting point 34 and the vehicle reference point 36 of the vehicle 20 (see FIG. 1) needs to be maintained with respect to the distance 44 between the location 40 and the mold reference point 42 of the seal assembly 30 (see FIGS. 2 and 3) so as to ensure proper fitment, alignment, and operation of the seal assembly 30. As will be appreciated from the subsequent description below, slight dimensional variations of the individual components of the seal assembly 30, along with manufacturing process variations, can cause a so-called “tolerance stack-up” during manufacturing which, in turn, can complicate maintaining the distance 44 within acceptable tolerance ranges.

In certain embodiments, one or more of the first strip ends 62 of the first strip 46 of seal assembly 30 may be “notched” to receive or otherwise align with one or more of the second and/or third strips 48, 50 prior to formation of the joint mold 52, as described in greater detail below. To that end, in one embodiment, as shown best in FIGS. 3 and 6, the first strip 46 may be provided with an end notch, generally indicated at 76, having a stepped profile that helps align with the second and/or third strip 48, 50 prior to the formation of the joint mold 52 of the seal assembly 30.

In the representative embodiment depicted herein, the locator 54 is pre-formed via a molding process (by way of non-limiting example, via injection molding, transfer molding, blow molding, and the like) from a thermoplastic such as Polypropylene (PP) or High-Density PolyEthylene (HD-PE), prior to heat bonding of the locator 54 to the first strip 46. However, those having ordinary skill in the art will appreciate that the locator 54 could be formed from any suitable material sufficient to bond to the first strip 46 and to facilitate proper alignment of the seal assembly 30, as described above, without departing from the scope of the present invention.

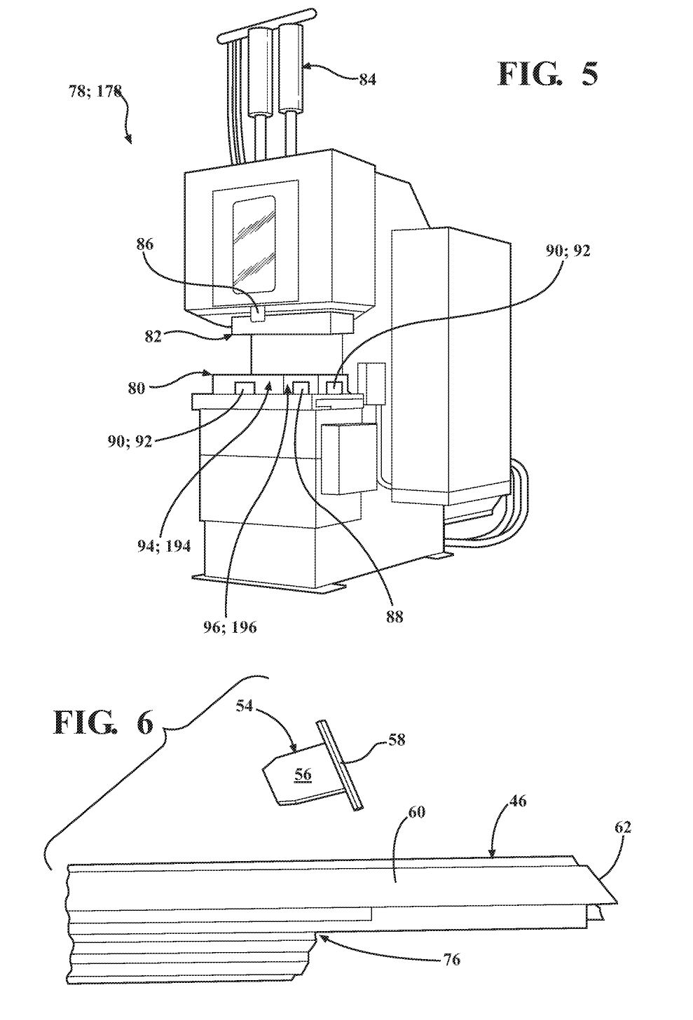

Referring now to FIG. 5, a molding system for forming the seal assembly 30 is depicted generically at 78. The molding system 78 generally includes a first mold subassembly 80 and a second mold subassembly 82. Here, the first mold subassembly 80 is generally configured to support the various components which cooperate to subsequently define the formed seal assembly 30, as described in greater detail below, and the second mold subassembly 82 is generally configured to engage against the first mold subassembly 80 via force from one or more rams, generally indicated at 84, and employs an injector 86 to form the joint mold 52. Those having ordinary skill in the art will appreciate that the molding system 78, including the first mold subassembly 80, the second mold subassembly 82, the rams 84, and/or the injector 86, could be configured or otherwise implemented in a number of different ways without departing from the scope of the present invention. Furthermore, as will be appreciated from the subsequent description below, one or more components of the molding system 78 may be provided with a heating element 88 configured to selectively direct heat to a specific area, such as may be employed to heat bond the foot 58 of the locator 54 to the first strip 48. Here, the heating element 88 could be of any suitable type or configuration, such as an electrically-powered resistive element, an inductive heating element, or the flow of heated fluid such as steam, hot oil, and the like. Conversely, one or more components of the molding system 78 may be provided with a water jacket 90 arranged in fluid communication with a source of fluid 92 and configured to direct heat away from a specific area, such as may be employed to facilitate improved throughput of the molding system 78 in use. Here, the source of fluid 92 could be a liquid such as water or another coolant, or could be a gas such as air or nitrogen.

Referring now to the embodiment of the molding system 78 depicted in FIGS. 7-9, the first mold subassembly 80 generally includes a molding apparatus 94 and a locator apparatus 96. Here, the molding apparatus 94 has a first receptacle 98, a second receptacle 100, a third receptacle 102, and defines a mold cavity 104. The locator apparatus 96, in turn, has or otherwise defines a locator receptacle 106 which is arranged outside of the mold cavity 104 and which is shaped to receive the tab 56 of the locator 54, as described in greater detail below. In the embodiment of the locator apparatus 96 of the molding system 78 illustrated in FIGS. 7-9, the locator apparatus 96 and the molding apparatus 94 are formed integrally.

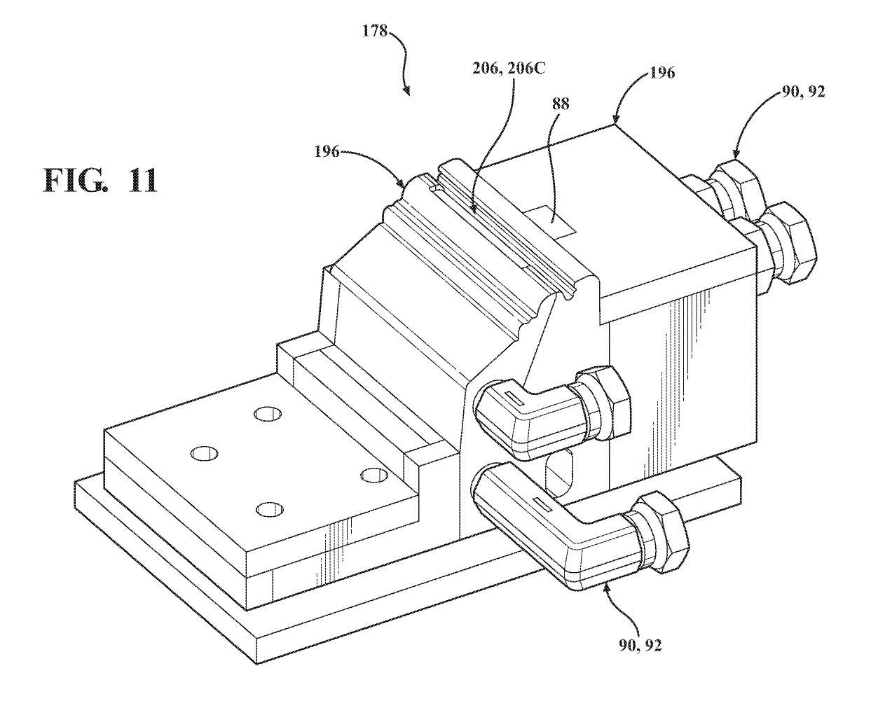

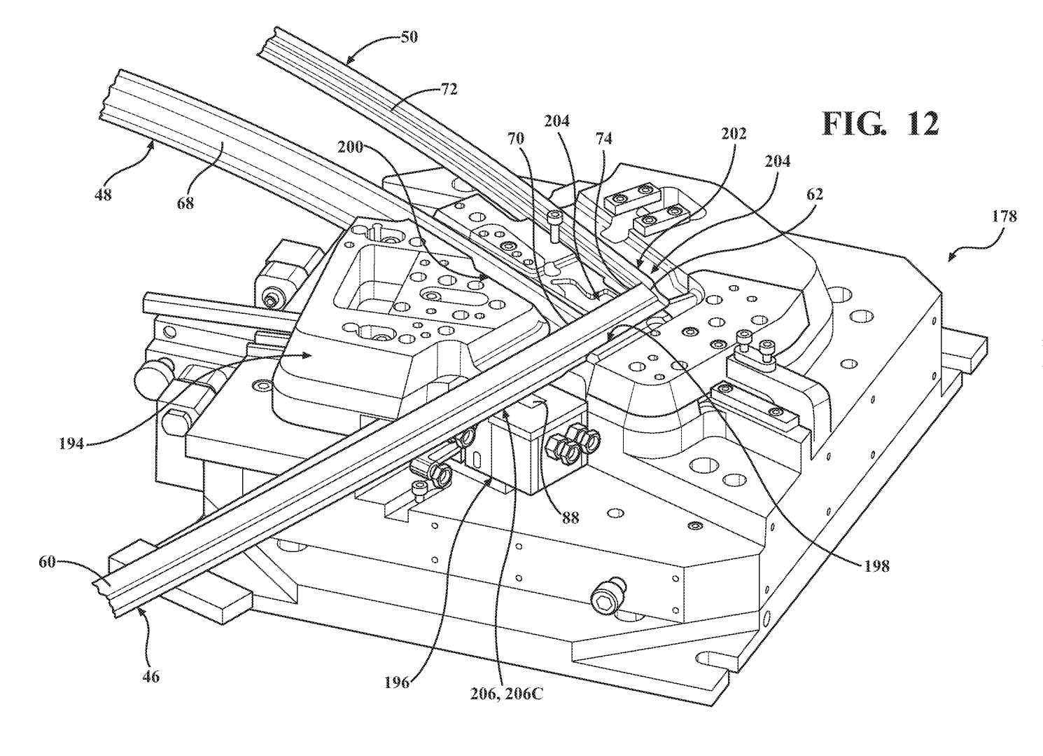

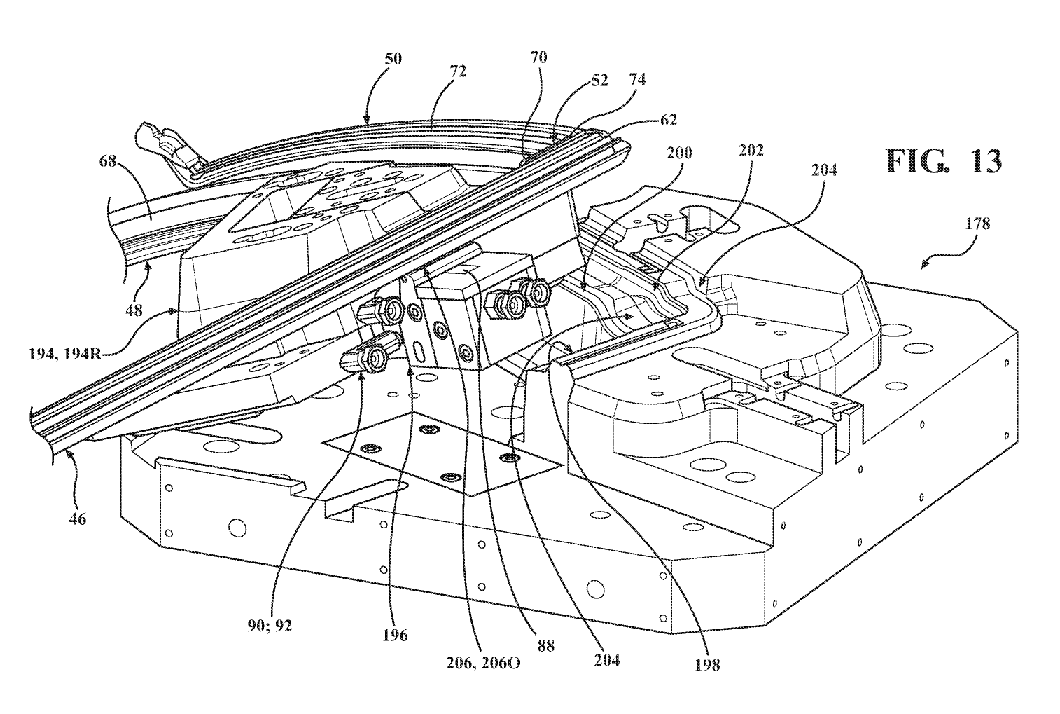

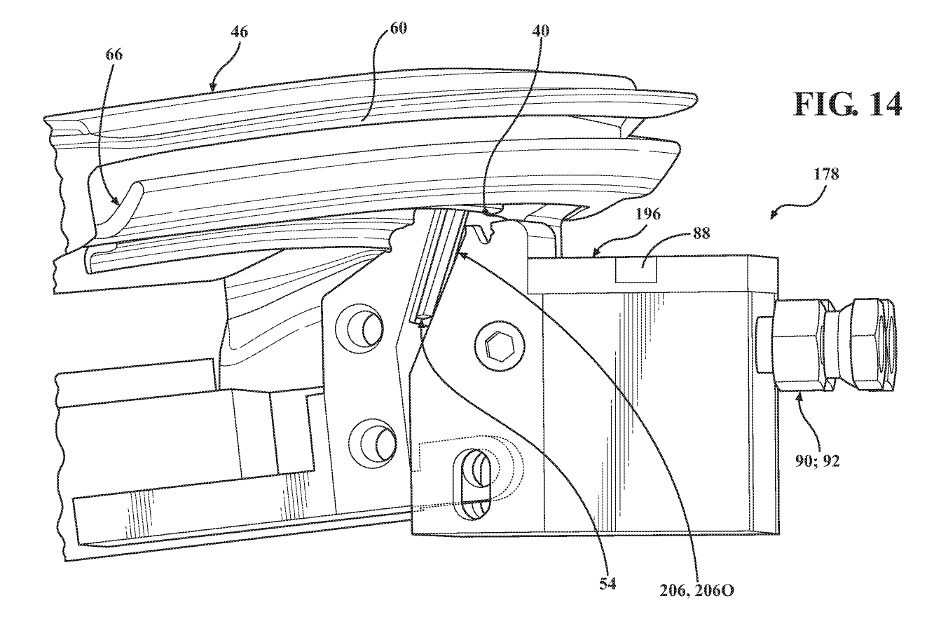

As noted above, the molding system 78 can be implemented in a number of different ways. To that end, another embodiment of a molding system 178 is illustrated in FIGS. 11-14 and employs a first mold subassembly 180 with a molding apparatus 194 and a locator apparatus 196 which is formed separately from the molding apparatus 194. In this embodiment, the locator apparatus 196 is provided with a locator receptacle 206 and is movable between a closed orientation 206C (see FIG. 11) and an opened orientation 206O (see FIGS. 13 and 14), such as via one or more actuators (not shown, but generally known in the related art). Here, the molding apparatus 194 is similarly provided with a first receptacle 198, a second receptacle 200, and a third receptacle 202, and defines a mold cavity 204. As is depicted in FIG. 13, in this embodiment, certain portions of the molding apparatus 194 are movable with the locator apparatus 196 into a released orientation 194R, such as with one or more actuators (not shown, but generally known in the related art), which may be implemented to position the seal assembly 30 advantageously for removal after the joint mold 52 has been formed (compare FIG. 13 with FIG. 12).

As noted above, the present invention is directed towards a method of manufacturing the seal assembly 30 described above by utilizing molding systems 78, 178 of the types described herein and depicted throughout the drawings. Moreover, it will be appreciated that the molding systems 78, 178 illustrated in FIGS. 7-9 and 11-14, respectively, are substantially similar. Thus, for the purposes of clarity and consistency, unless otherwise indicated below, subsequent description of the inventive method will make reference to the various components of both types of molding system 78, 178.

The method includes the step of extruding the first strip 46 of material to form the first body 60 extending between the opposed first strip ends 62, and the step of extruding the second strip 48 of material to form the second body 68 extending between the opposed second strip ends 70. The method further includes the steps of providing the locator 54 and positioning the locator 54 into the locator receptacle 106, 206. The method further includes the step of positioning one of the first strip ends 62 into the first receptacle 98, 198 with a portion of the first body 60 engaging a portion of the locator 54, and the step of positioning one of the second strip ends 70 into the second receptacle 100, 200. The method further includes the step of directing material into the mold cavity 104, 204 to form the joint mold 52 bonding the first strip 46 together with the second strip 48 with the joint mold 52 defining the mold reference point 42. The method further includes the step of bonding the locator 54 outside of the mold cavity 104, 204 at the location 40 along the first strip 46 spaced from the mold reference point 42 such that the distance 44 between the bonded locator 54 and the mold reference point 42 is equal to the predetermined distance 38 between the mounting point 34 and the vehicle reference point 36 of the vehicle 20.

In one embodiment, the step of positioning the locator 54 into the locator receptacle 106, 206 occurs prior to the step of directing material into the mold cavity 104, 204.

In one embodiment, the method further includes the step of forming the locator 54 with the locator 54 having the tab 56 and the foot 58. Here, the step of forming the locator 54 may occur prior to the step of extruding the first strip 46 of material. Here too in this embodiment, the step of positioning the locator 54 into the locator receptacle 106, 206 further includes the step of positioning at least a portion of the tab 56 of the locator 54 into the locator receptacle 106, 206. Further, in this embodiment, the step of positioning one of the first strip ends 62 into the first receptacle 98, 198 may further include the step of abutting the portion the first body 60 of the first strip 46 against the foot 58 of the locator 54.

It will be appreciated that the step of bonding the locator 54 outside of the mold cavity 104 can be achieved in different ways, depending on application requirements and the specific configuration of the molding system 78, 178. By way of non-limiting example, this step could be achieved using heat conducted between the molding apparatus 94, 194 and the locator apparatus 96, 196, such as may be generated during the step of directing material into the mold cavity 104, 204 which, in turn, may be further defined as injecting molten material, such as EDPM rubber, into the mold cavity 104, 204 with the injector 86 (see FIG. 5) so as to form the joint mold 52 and thereby bond the second strip 48 and the first strip 46 together. Put differently, in this embodiment, heat in the molding apparatus 94, 194 and the locator apparatus 96, 196 generated during formation of the joint mold 52 also serves to bond the pre-formed locator 54 to the first strip 46 of the seal assembly 30. It will be appreciated that this arrangement enables simultaneous formation of the joint mold 52 and bonding of the pre-formed locator 54. However, it will be appreciated that different arrangements are contemplated by the present disclosure. By way of non-limiting example, the locator receptacle 106, 206 may be thermally isolated from the mold cavity 104, 204 such that the step of bonding the locator 54 is performed independent of the step of directing material into the mold cavity 104, 204.

In one embodiment, the step of bonding the locator 54 outside of the mold cavity 104, 204 to the first body 60 further includes the step of heating the locator receptacle 106, 206 with the heating element 88 (see FIG. 5) to at least partially melt the locator 54 at the location 40 along the first strip 46. Here, it will be appreciated that the heating element 88 may be arranged such that at least a portion of the foot 58 of the locator 54 melts at the location 40 along the first strip 46.

In one embodiment, the method further includes the step of cooling the locator receptacle 106, 206 with the water jacket 90 arranged in fluid communication with the source of fluid 92 (see FIG. 5). In this embodiment, the step of cooling the locator receptacle 106, 206 may occur after the step of bonding the locator 54 outside of the mold cavity 104, 204 to the first body 60.

In one embodiment, the method further includes the step of releasing the bonded locator 54 from the locator receptacle 106, 206. In this embodiment, the step of releasing the bonded locator 54 may occur after the steps of directing material into the mold cavity 104, 204 and bonding the locator 54 outside of the mold cavity 104, 204 to the first body 60. Similarly, in one embodiment, the method may further include the steps of removing the joint mold 52 from the mold cavity 104, 204 and removing the bonded locator 54 from the locator receptacle 106, 206. In this embodiment, the step of removing the joint mold 52 may further include the step of removing the first and second strips 46, 48 in unison with the removal of the joint mold 52 and the step of removing the bonded locator 54 in unison with the removal of the first strip 46. Similarly, in one embodiment, the method further includes the step of removing the joint mold 52, the first strip 46, and the second strip 48 from the molding apparatus 94, 194, and removing the bonded locator 54 from the locator receptacle 106, 206.

In this way, the method of the present invention affords significant improvements with respect to maintaining the distance 44 between the location 40 and the mold reference point 42 so as to correspondingly achieve the requisite predetermined distance 38 between the mounting point 34 and the vehicle reference point 36 of the vehicle 20 while, at the same time, mitigating tolerance stack-up which could otherwise occur during manufacturing from geometric variations in the various components of the seal assembly 30.

While the invention has been described with reference to the examples above, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all examples falling within the scope of the appended claims.

1. A method of manufacturing a seal assembly for attachment to a vehicle having a mounting point and defining a vehicle reference point spaced from the mounting point at a predetermined distance, the method utilizing a molding apparatus having a first receptacle and a second receptacle and defining a mold cavity, and a locator receptacle mounted to the molding apparatus outside of the mold cavity, said method comprising the steps of:
extruding a first strip of material to form a first body extending between opposing first strip ends;
extruding a second strip of material to form a second body extending between opposing second strip ends;
providing a locator;
positioning the locator into the locator receptacle;
positioning one of the first strip ends into the first receptacle with a portion of the first body engaging a portion of the locator;
positioning one of the second strip ends into the second receptacle;
directing material into the mold cavity to form a joint mold bonding the first strip together with the second strip with the joint mold defining a mold reference point; and
bonding the locator outside of the mold cavity to the first body at a location along the first strip spaced from the mold reference point such that a distance between the bonded locator and the mold reference point is equal to the predetermined distance between the mounting point and the vehicle reference point.

2. The method as set forth in claim 1, wherein the step of positioning the locator occurs prior to the step of directing material into the mold cavity.

3. The method as set forth in claim 1, wherein the locator receptacle is thermally isolated from the mold cavity such that the step of bonding the locator is performed independent of the step of directing material into the mold cavity.

4. The method as set forth in claim 1, wherein the step of bonding the locator outside of the mold cavity to the first body further includes the step of heating the locator receptacle with a heating element to at least partially melt the locator at the location along the first strip.

5. The method as set forth in claim 1, further comprising the step of cooling the locator receptacle with a water jacket arranged in fluid communication with a source of fluid.

6. The method as set forth in claim 5, wherein the step of cooling the locator receptacle occurs after the step of bonding the locator outside of the mold cavity to the first body.

7. The method as set forth in claim 1, further comprising the step of releasing the bonded locator from the locator receptacle.

8. The method as set forth in claim 7, wherein the step of releasing the bonded locator occurs after the steps of directing material into the mold cavity and bonding the locator outside of the mold cavity to the first body.

9. The method as set forth in claim 7, further comprising the steps of removing the joint mold from the mold cavity and removing the bonded locator from the locator receptacle.

10. The method as set forth in claim 9, wherein the step of removing the joint mold further includes the step of removing the first and second strips in unison with the removal of the joint mold and the step of removing the bonded locator in unison with the removal of the first strip.

11. The method as set forth in claim 1, further including the step of forming the locator with the locator having a tab and a foot.

12. The method as set forth in claim 11, wherein the step of forming the locator occurs prior to the step of extruding the first strip of material.

13. The method as set forth in claim 11, wherein the step of positioning the locator into the locator receptacle further includes the step of positioning at least a portion of the tab of the locator into the locator receptacle.

14. The method as set forth in claim 11, wherein the step of positioning one of the first strip ends into the first receptacle further includes the step of abutting the portion of the first body of the first strip against the foot of the locator.

15. The method as set forth in claim 11, wherein the step of bonding the locator outside of the mold cavity to the first body further includes the step of heating the locator receptacle with a heating element to melt at least a portion of the foot of the locator at the location along the first strip.

16. The method as set forth in claim 1, further comprising the step of removing the joint mold, the first strip, and the second strip from the molding apparatus, and removing the bonded locator from the locator receptacle.
